(19) United States
(12) Patent Application Publication
(10) Pub. No.: US 2025/0035487 A1
(43) Pub. Date: Jan. 30, 2025

(54) CHIRP MODULATION SIMULATED RAMAN SCATTERING MICROSCOPY

(71) Applicant: National Research Council of Canada, Ottawa (CA)

(72) Inventors: Adrian PEGORARO, Ottawa (CA); Albert STOLOW, Ottawa (CA)

(21) Appl. No.: 18/715,584

(22) PCT Filed: Dec. 2, 2022
(86) PCT No.: PCT/CA2022/051772

§ 371 Date: May 31, 2024

Related U.S. Application Data
(60) Provisional application No. 63/285,808, filed on Dec. 3, 2021.

(51) Int. Cl. G01J 3/44; G01J 3/10; G01J 3/427; G01N 21/65

(52) U.S. Cl. CPC G01J 3/44; G01J 3/10; G01J 3/427; G01N 21/65; G01N 2201/06113

(57) ABSTRACT

A modulation method comprising steps of: a) generating a first signal having a first train of short pulses having a first frequency, and a second signal having a second train of short pulses having a second frequency, wherein each of the signals are associated with a negative or positive sign; b) maintaining a narrow frequency difference between the frequencies; c) imposing chirped modulation on each of the signals to achieve a desired spectral resolution, such that each signal is associated with a chirp having a first sign and a second sign; and d) switching between the signs for each signal over a frequency range, and detecting for each frequency of said frequency range, a spectral response resulting from a transfer of said modulation between the signals wherein the chirp sign of each of the signals is different, thereby obtaining hyperspectral data of said spectral response over said frequency range.

### FIELD

Aspects of this disclosure relate to methods and systems for modulation transfer techniques such as Stimulated Raman Scattering.

### BACKGROUND

In optical microscopy, both spatial resolution (smallest discernible object) and contrast (discerning object from background) are critically important. Contrast is often achieved by adding exogenous dyes or stains which ‘label’ the object of interest. However, in many cases exogenous contrast agents cannot be applied or may alter the object under study. For many microscopy problems, the options for achieving label-free contrast are limited. Coherent Raman Microscopy (CRM) encompasses a range of nonlinear optical techniques which provide chemical-specific, label-free image contrast via Raman spectroscopy (molecule specific vibrational modes). It has been widely applied to biomedical applications and has found increasing use in other fields such as material sciences and geology. In standard CRM approaches, background signals due to competing nonlinear optical processes exist and limit overall image contrast. Various ‘background reduction’ schemes have been proposed and demonstrated, but these come with significant drawbacks.

Most CRM implementations make use of two ultrashort lasers whose frequency difference is set to match the frequency of the vibrational Raman mode of interest, thus achieving Raman resonance and therefore object contrast. The highest signal-to-background ratios in CRM are typically achieved using high speed (e.g. MHz) optical modulation techniques. One variant of CRM, Stimulated Raman Scattering (SRS) requires optical modulation to function and has been demonstrated using amplitude, polarization, and/or frequency modulation. Another variant, Coherent anti-Stokes Raman Scattering (CARS) microscopy can operate without modulation but achieves its high sensitivity when used in a frequency modulation configuration.

In SRS microscopy, amplitude modulation is the most widely adopted Raman-contrast technique but is not background-free due to other competing nonlinear optical processes (e.g. cross-phase modulation, two-photon absorption, thermal lensing) which also contribute to the modulated signal. This means that image brightness is often not due uniquely to Raman resonance in the object of interest, thus reducing contrast. The definitive proof of Raman contrast is to scan the Raman spectrum while imaging (cf. hyperspectral imaging). Frequency and/or Polarization modulation SRS schemes are either challenging to implement (e.g. ideally require more than two laser beams) or remove only certain types of background signals (e.g. cross-phase modulation). CARS microscopy has similar background contrast issues plus an additional coherent non-resonant background that optically interferes with the desired signal, distorting Raman spectra. Frequency and/or Polarization modulation reduces this coherent background but cannot correct for Raman spectral distortions.

Stimulated Raman Scattering (SRS) microscopy relies on modulation to achieve contrast¹⁻³. In its initial demonstration using amplitude modulation (AM)⁴ it overcame the non-resonant background problem that had plagued coherent anti-Stokes Raman scattering (CARS) microscopy⁵. Nonetheless, due to other optical effects, both linear and nonlinear, background signals can still be present in AM-SRS^{6,7}, leading to the development of alternative modulation schemes. Polarization modulation (PM)⁸, frequency modulation (FM)^{9,10}, and time delay (i.e. linear phase)¹¹ modulation were recognized early on as possible alternative modulation schemes¹² and have been demonstrated for nonlinear optical microscopy. Indeed, these modulation schemes have a long history in optical communication and form the basis of advanced telecommunication schemes¹³. Beyond these traditional techniques, when using short pulses and nonlinear optics, other types of modulation schemes become possible. For example, coherent control using phase and amplitude shaping of an optical pulse can reduce background signals in coherent Raman microscopy (CRM)^{14,15}.

### SUMMARY

In one aspect of the disclosure, there is provided a modulation method comprising steps of:
a) generating a first signal having a first train of short pulses having a first frequency, and a second signal having a second train of short pulses having a second frequency, wherein each of the first signal and the second signal is associated with a negative or positive sign;
b) maintaining a narrow frequency difference between the first frequency and the second frequency;
c) imposing chirped modulation on the first signal and the second signal to achieve a desired spectral resolution, such that each signal is associated with a chirp having a first sign and a second sign; and
d) switching between the first sign and the second sign for each signal over a frequency range, and detecting for each frequency of said frequency range, a spectral response resulting from a transfer of said modulation between the first signal and the second signal wherein the chirp sign of the first signal is different from the chirp sign of the second signal, thereby obtaining hyperspectral data of said spectral response over said frequency range.

In another aspect of the disclosure, there is provided a method of imaging a sample, the method comprising:
a) generating a pump beam and a Stokes beam comprising of a train of short pulses and having a tunable optical frequency difference;
b) imposing chirped modulation on the pump beam and Stokes beam to achieve a desired spectral resolution, such that each beam is associated with a chirp having a first sign and a second sign; and
c) probing regions of the sample with the pump beam and Stokes beam jointly, said probing comprising switching between the first sign and the second sign for each beam over an optical frequency range, said probing further comprising detecting, for each frequency of said optical frequency range for each of the probed regions, an optical response of the sample resulting from a transfer of said modulation between the pump beam and the Stokes beam when the chirp sign of the pump beam is different from the chirp sign of the Stokes beam, thereby obtaining hyperspectral data of said optical response over said optical frequency range for each of the probed regions.

In another aspect of the disclosure, there is provided an imaging system comprising:
a light source system configured to produce a first set of light pulses in a predefined first wavelength region and a second set of light pulses in a predefined second wavelength region;
a modulator to positively chirp the first set of light pulses and negatively chirp the second set of light pulses;
a first optical system coupled to the light source system, the first optical system comprising optics configured to combine the first set of chirped light pulses and the second set of chirped light pulses into a set of combined light pulses, wherein each of the combined light pulses comprises a first pulse from the first set of chirped light pulses and a second pulse from the second set of chirped light pulses;
a sample holder coupled to the first optical system and configured to hold a sample for analysis, wherein at least a portion of the sample is exposed to a plurality of the combined light pulses;
a photodetector configured to convert an optical signal resulting from an interaction of the plurality of the combined light pulses with the sample;
an amplifier configured to remove the second set of chirped light pulses;
a second optical system configured to collect an interaction light signal resulting from an interaction of the at least one of the combined light pulses with the at least one of the particles;
an analysis system comprising spectrally dispersive means, the analysis system configured to measure a plurality of spectral components of the interaction light signal.

In another aspect of the disclosure, there is provided a modulation scheme for suppressing noise, the method comprising:
a) generating a first signal having a first train of short pulses having a first frequency, and a second signal having a second train of short pulses having a second frequency, wherein each of the first signal and the second signal is associated with a negative or positive sign;
b) maintaining a narrow frequency difference between the first frequency and the second frequency;
c) imposing chirped modulation on the first signal and the second signal to achieve a desired spectral resolution, such that each signal is associated with a chirp having a first sign and a second sign; and
d) switching between the first sign and the second sign for each beam over a frequency range, and detecting for each frequency of said frequency range, a spectral response resulting from a transfer of said modulation between the first signal and the second signal wherein the chirp sign of the first signal is different from the chirp sign of the second signal, thereby obtaining hyperspectral data of said spectral response over said frequency range.

Advantageously, the modulation scheme is based on rapidly modulating the sign of the chirp, such that only the Raman resonances are detected amplified and non-resonant background channels are substantially suppressed or removed, thereby enhancing the contrast and sensitivity in CRM.

### BRIEF DESCRIPTION OF THE DRAWINGS

FIG. 1a shows an exemplary imaging system which employs spectral-focusing chirp modulation (CM) stimulated Raman scattering (SRS);

FIG. 1b shows a flowchart outlining the exemplary steps for implementing CM-SRS using the exemplary spectral focusing CRM 10 of FIG. 1:

FIG. 1c shows a spectral resolution of a pump laser beam signal, a stokes laser beam signal and a Raman mode probed signal;

FIG. 1d shows a spectral resolution of a pump laser beam signal, a stokes laser beam signal with an opposite sign (to the stokes laser beam signal in FIG. 1c, and a Raman mode probed signal;

FIG. 2a shows a Raman spectrum in the CH region using matched (AM) and mismatched (chirped) beams using 10% DMSO in deuterated water;

FIG. 2b shows a Raman spectrum in the CH region using matched (AM) and mismatched (chirped) beams using 0.1% DMSO in deuterated water;

FIG. 2c shows a plot of the absolute peak height for the DMSO signal measured at 2913 cm⁻¹ as function of concentration for both AM and CM-SRS signals;

FIG. 3a shows recorded Raman spectra using AM-SRS at 1520 cm⁻¹;

FIG. 3b shows recorded Raman spectra using CM-SRS at 1350 cm⁻¹;

FIG. 3c shows recorded Raman spectra using AM-SRS at 1350 cm⁻¹;

FIG. 3d shows recorded Raman spectra using CM-SRS at 1350 cm⁻¹;

FIG. 3e shows the Raman spectrum measured using AM-SRS, CM-SRS, and CARS;

FIG. 4a shows a plot of signal intensity over time using CM-SRS;

FIG. 4b shows a plot of signal intensity over time using CM-SRS; and

FIG. 4c shows a plot of signal intensity over time using CM-SRS.

### DETAILED DESCRIPTION

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

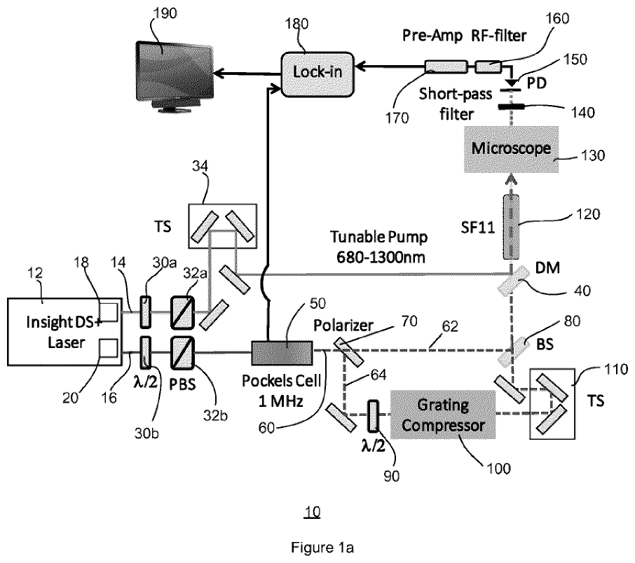

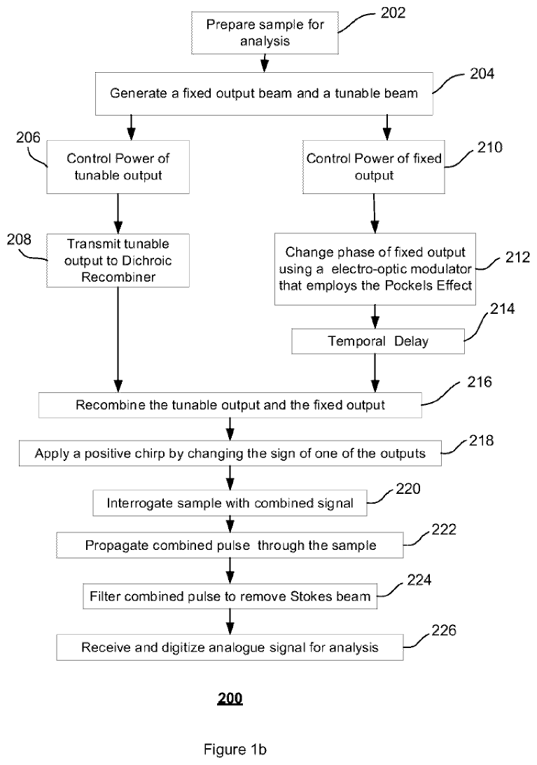

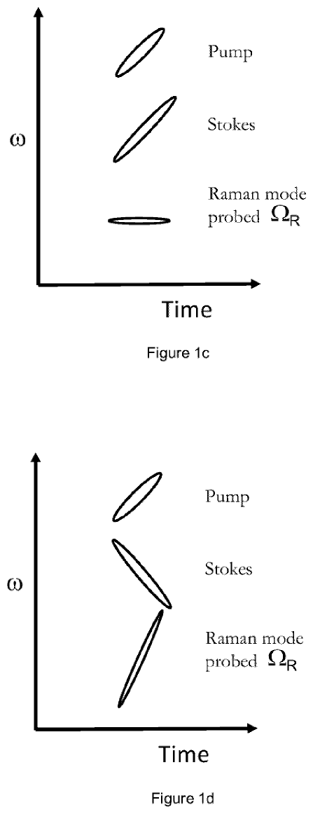

Referring to FIG. 1, there is shown an exemplary imaging system 10 which may be used to carry out the steps of the present method. The imaging system 10 employs spectral-focusing chirp modulation (CM) stimulated Raman scattering (SRS) and comprises a light-generating module 12 configured to generate two separate, but synchronized, pulsed coherent light beams, that is, a pump beam 14 and a Stokes beam 16. In one exemplary implementation, a tunable laser 18 is used to generate the pump beam 14 such that its optical frequency (or wavelength) can be controllably changed, whereas a laser with a fixed spectral output 20 may be used to generate the Stokes beam 16 at a fixed frequency. In other exemplary implementations, the frequency of the pump beam 14 may be kept fixed, whereas the frequency of the Stokes beam 16 is tuned. In one exemplary implementation, a dual beam tunable laser, e.g. a Spectra-Physics InSight® DS+™ Dual from Newport Corporation, U.S.A., which enables a variety of pump-probe and multiphoton microscopy techniques was used to produce both the pump beam 14 and the Stokes beams 16. In one example, the Stokes beam 16 is a fixed output with a central wavelength of 1040 nm and a transform-limited pulse duration of 220 fs (linearly stretched to approximately 1.1 ps). The pump beam 14 is tunable over the range 680-1300 nm. The spectral bandwidth of the pump beam 14 corresponds to a transform limited pulse duration of approximately 150 fs (linearly stretched to approximately 1.4 ps). In one example, dual output light-generating module 12 produces two synchronized beam outputs 14, 16 operating at 80 MHz repetition rate.

The terms “pump beam” and “Stokes beam” are meant to be understood as they are commonly used in the field of stimulated Raman scattering, such as the CARS and SRS techniques. The expression “Stokes beam” is generally understood to refer to the one of the two laser light beams having the lower optical frequency. These names are historically related to a “Stokes” Raman scattering process where the excitation light is re-scattered at a lower frequency due to interaction with a sample, although one skilled in the art will readily understood that the origin of this terminology is not limitative to its current use on the art. The frequency difference between the two beams is tuned in order to obtain the Raman spectrum. It is the input of these two beams that results in the relatively higher SRS and CARS signals compared to spontaneous Raman.

As is known in the art of optical microscopy, the pump beam and Stokes beam are generally pulsed light beams, having a pulse width and repetition rate suitable for the purposes of the experiment being performed. Typically, light pulses in the femtosecond to picosecond duration range may be used. The tuning of the frequency difference between the two beams may be performed in any manner known to those skilled in the art.

The tunable output 16 is passed through a half-wave plate 30a and a polarizing beam splitter (PBS) 32a to control power before being sent to a variable delay stage 34 and then to a dichroic recombiner 40. The fixed output 22 is passed through a half-wave plate 30a and a polarizing beam splitter (PBS) 32b to control the power of the beam before being sent to variable delay stage 34 which includes a translation stage, and then sent to an electro-optic modulator 50 for modulating an optical property of the beams 14, 16. In the illustrated system, the electro-optic modulator 50 is embodied by a Pockels cell (350-160, Conoptics, USA) provided in the path of the Stokes beam 26. It will be readily understood that although the modulator is shown here as acting on the Stokes beam 16, in other variants it may act on the pump beam 14. In one example, the electro-optic modulator 50 is modulated at 1 MHz, and the driving waveform for the electro-optic modulator 50 is provided by a function generator, such as DS345, Stanford Research Systems, USA.

As a person of skill in the art will appreciate, in AM-SRS, one output of the electro-optic modulator 50 is blocked and the other is sent to the dichroic recombiner 40. However, in the exemplary imaging system 10, the output 60 from the electro-optic modulator 50 is spit into two outputs 62, 64 by polarizer 70, such that one output 62 is sent directly to a 50:50 beam splitter 80, and the other output 64, the previously blocked output of the electro-optic modulator 50, is sent through a half-wave plate 90 to rotate the beam 64 to the same polarization as the other output 62 and then to a grating compressor 100 followed by a computer-controlled delay stage 110 including a translation stage. The two 1040 nm beams 62, 64, are then recombined on the 50:50 beam splitter 80 before being sent to the dichroic recombiner 40 where the pulses of both the pump beam 14 and the Stokes beam 16 are recombined and transmitted to a fixed optical path length of dispersive glass 120 e.g. SF11 glass in the path of the pump beam 14 and the Stokes beam 16. By blocking one arm of the CM-SRS setup 10, it is thus possible to seamlessly switch between AM and CM-SRS.

The imaging system 10 is configured to probe a sample with the combined pump beam 14 and Stokes beam 16. In one example, a microscope 130 employs galvo mirrors (GVSM002-US, Thorlabs, USA) connected to a microscope frame (Olympus IX-71), such that, the combined pump and Stokes beams 14, 66 traverse the galvo mirrors and are focused onto the sample through a microscope objective. The interaction of the pump beam 14 and the Stokes beam 16 with the sample leads to a modulation transfer between the pump beam 14 and the Stokes beam 16, which can be detected using a homodyne or heterodyne technique such as described below.

The forward propagating light from the interaction is collected using an objective lens (e.g. LUMPlanFI/IR, 40×, NA 0.8 water immersion, Olympus, Japan). The collected light was filtered by a short-pass filter 140 (e.g. BrightLine 850/310, Semrock, USA and 1064-71 NF, Iridian, Canada) to remove the Stokes beam 16 before being sent to a photo-diode 150 (e.g. FDS10X10, Thorlabs, USA) operating under reverse bias. The photo-diode signal is filtered using 1 MHz bandpass filter 160 (e.g. #3128, KR Electronics, USA) before being amplified by a transimpedance amplifier 170 (e.g. DHCPA-100 Femto Messtechnik, GmbH, Germany). Next, the output of the amplifier 170 is sent to a lock-in amplifier 180 (e.g. UHFLI, Zurich Instruments, Switzerland) which is referenced to the drive signal for the Electro-optic modulator 50. Typically, a 20 us time constant was used on the lock-in amplifier 180. Lastly, the output from the lock-in amplifier 180 is fed into a data acquisition module 190.

In one exemplary implementation, measurements of DMSO spectra and HEPG2 cells used a 60×, 1.2 NA water objective while measurements of a sweet potato used a 20×, 0.75 NA air objective. All data collection and motion of the galvanometer mirrors is synchronized using ScanImage, from Vidrio Technologies LLC, U.S.A. For all measurements, power in each 1040 nm air of the AM and CM-SRS setups is measured to be 50 mW before the microscope. For DMSO measurements, power in the tunable arm is set to 796 nm center wavelength with an average power of 100 mW. For sweet potato measurements, the tunable arm was set at 898, 912, and 929 nm center wavelength with 50 mW average power set at 50 mW. For measurements of HEPG2 cells, the tunable beam is set at a center wavelength of 800 nm and average power of 50 mW for measurements around a Raman shift of 2850 cm⁻¹ and at a center wavelength of 844 nm and an average power of 100 mW for measurements around a Raman shift of 2200 cm⁻¹.

In one implementation, the quadratic phase term of a short optical pulse is modulated to remove background noise in SRS microscopy, i.e. the optical chirp. This process, or chirp modulation SRS (CM-SRS) is akin to an unsharp mask in digital image processing but in this case it is applied to the spectral domain. This implementation is derived from spectral focusing coherent Raman microscopy (CRM)¹⁷⁻¹⁹ and maintains the ability to easily perform spectral scanning and multimodal imaging.

In SRS microscopy, background can arise from numerous terms, including cross-phase modulation, two-photon absorption, thermal effects, and variation in the linear refractive index of the media.^{6,7,9} PM-SRS can eliminate some of these signals but assumes a homogeneous background response. FM-SRS, and variants such as SR-GOLD20, can eliminate background signals if there are no chromatic effects and the system response only depends on the frequency differences among the excitation beams; unfortunately for many classes of samples the assumption of achromaticity breaks down. In one exemplary implementation, in CM-SRS, restrictions on background homogeneity and achromatic responses are relaxed because the excitation beams are co-polarized and the modulated beam is at a single central frequency.

Looking at FIG. 1b, there is shown a flowchart 200 outlining the exemplary steps for implementing CM-SRS using the exemplary imaging system 10 of FIG. 1. In step 202, a user or operator prepares a sample containing a plurality of particles for analysis or optical interrogation. At step 204, using the light source 12 such as a dual beam tunable laser, two lasers beams are outputted, and synchronized at a predefined rate. In one example, the two outputs are the pump beam 14 and the Stokes beam 16, with one of these outputs being tunable, that is, having an optical frequency (or wavelength) that can be controllably changed. In one example, the pump beam 14 and the Stokes beam 16 have a tunable frequency difference. This may, for example, be achieved using a light generating module such as described above or devices or assemblies of devices equivalent thereto.

In one implementation, a single laser having dual beam capabilities or a sufficiently broad bandwidth may be used to generate both the pump beam 14 and the Stokes beam 16. In step 206, the tunable output is passed through a half-wave plate 30a and polarizing beam splitter (PBS) 32a to control the power of the beam before being sent to a variable delay stage 34 and then to a dichroic recombiner 40 (step 208). Contemporaneously, the fixed output 22 is passed through a half-wave plate 30a and polarizing beam splitter (PBS) 32b to control the power of the beam (step 210) and then sent to an electro-optic modulator 50 that employs the Pockels Effect (linear electro-optics effect). For example, using the Pockels Effect, the electro-optic modulator 50 uses a modulation reference signal from a modulation reference signal generator to cause a change in phase of the induced ordinary ray (step 212). In step 214, the output from the electro-optic modulator 50 is subjected to a temporal delay by a computer-controlled delay stage 110.

In step 216, the two outputs are then recombined. Next, in step 218, a positive chirp by changing the sign of one of the outputs. Next, in step 220, the combined pulse interrogates the particles using the chirped-modulation Coherent anti-Stokes Raman Scattering (CARS) signal.

In step 222, the combined pulse propagates through the sample, and is collected by the microscope, and the collected light is filtered by a short-pass filter 140 to remove the Stokes beam (fixed or tunable) (step 224) for detection and amplification. The lock-in amplifier 180 uses the modulation reference signal drive signal for the electro-optic modulator 50 to single out a component of the signal at a specific reference frequency and phase. In step 226, the output from the lock-in amplifier 180 is fed into a data acquisition module 190, which converts any analog signals received into digitized equivalents; and optionally processes such received and digitized signals to improve their signal-to-noise characteristics. In addition, the data acquisition module 190 provides for a temporary storage of the received and digitized signals as associated items in a digital packet identified by its time stamp on an onboard memory module; and the data acquisition module 190 optionally transmits such digital packet to a computer module for further preliminary processing.

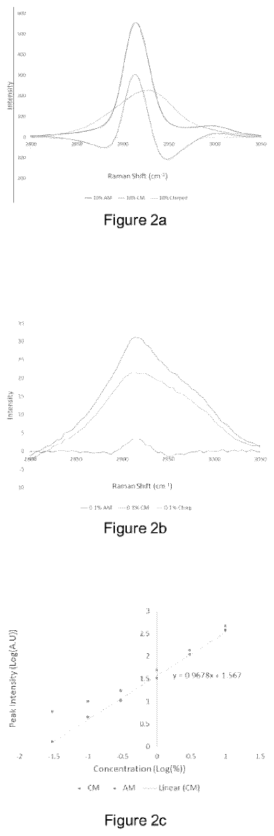

Chirp modulation will now be explained in more detail. Generally, in spectral focusing CRM, the pump and Stokes beams are chirped to achieve the desired spectral resolution: the spectral resolution is set by the instantaneous difference frequency between the two beams, as is illustrated in FIG. 1c. When the sign of the chirp of one beam e.g. the Stokes beam, is switched the resonant effect between the two beams 14, 16 becomes non-existent, as is shown in FIG. 1d. The “poor” spectral resolution achieved using the mismatched chirp would result in a blurred Raman spectrum if used for AM-SRS. This spectral domain argument can be understood by analogy with image processing in the spatial domain in which matched linear chirps act as a high-pass filter whereas mismatched linear chirps act as a low pass filter. To illustrate this effect, SRS spectroscopy is performed on a sample, for example, using 10% DMSO in deuterated water, the Raman spectrum in the CH region is measured using matched (AM) and mismatched (chirped) beams, as is illustrated in FIG. 2a. It is found that the measured spectra are dramatically different with clear Raman peaks visible using matched chirps and a nearly featureless spectrum with mismatched chirps.

In operation, CM-SRS effectively subtracts these two different responses since they are out of phase, allowing the peak positions to be recovered, as illustrated by the CM response in FIG. 2a. While the peak positions are recovered, it is also noticeable that the spectral shape has changed in CM-SRS, and there is “ringing” present. This ringing is akin to an over-sharpened image using an unsharp mask¹⁶ and in this case the ringing occurs because the blurred spectrum is dominated by resonant Raman effects. However, in a system where there is a significant non-resonant component, it is found that the ringing is largely eliminated. For example, using DMSO-deuterated water mixtures, but at progressively larger dilution factors, the resonant contribution to the signal may gradually diminish until the response is dominated by non-resonant cross-phase modulation. For example, at 0.1% DMSO concentration, the matched and mismatched chirp signals are very similar, as is shown in FIG. 2b. In CM-SRS, however, the Raman peaks are recovered.

Comparing the peak height of the AM and CM-SRS spectra, it is noticeable that the absolute signal is weaker for CM-SRS: however, the absolute peak height of the CM-SRS response scales linearly with concentration of the molecules of interest, much like it does for AM-SRS microscopy. Indeed, this linear regime is extended to lower concentration limits using CM-SRS microscopy compared to standard AM-SRS approaches because noise is suppressed. As can be seen in FIG. 2c, which shows a plot of the absolute peak height for the DMSO signal measured at 2913 cm⁻¹ as function of concentration for both AM and CM-SRS signals, the absolute signal for both AM and CM-SRS scales linearly with concentration at high signal levels while this scaling breaks down for AM-SRS when noise becomes a significant component of the total signal whereas the linear regime is extended for CM-SRS.

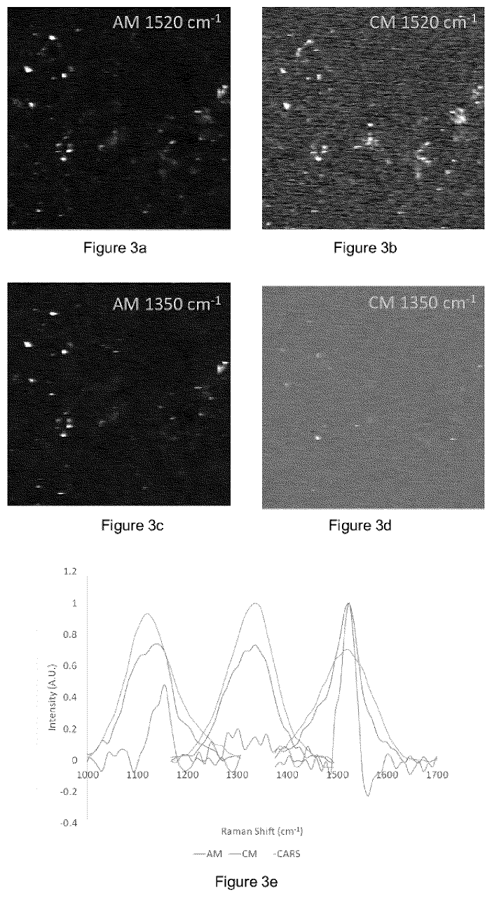

Beyond performing spectroscopy, CM-SRS allows for improved imaging in heterogeneous and complex media. For example, β-carotene is an important phytochemicals of many plants but is challenging to image using SRS microscopy given its large nonlinear response which is dominated by two-photon absorption: even using FM-SRS techniques it can be challenging to remove this non-resonant response because it is highly wavelength dependent and thus subject to the chromatic limitations of FM techniques²¹. To test the utility of CM-SRS to these types of systems, a slice of sweet potato which contains β-carotene and other compounds was imaged. The Raman response of β-carotene is distinguished by peaks near 1150 cm⁻¹ and 1520 cm^{-1 22,23}. To compare resonant and non-resonant responses, recorded Raman spectra across this range. Using AM-SRS, the presence of phytochemicals is evident by their strong response; however, the response is not specific and is similar at different Raman shifts, as can be seen comparing FIGS. 3a and 3c. Indeed, the Raman spectrum measured using AM-SRS is nearly indistinguishable from the CARS response which is dominated by non-resonant effects (see FIG. 3e). Using CM-SRS, however, it is found that the response is specific with little signal evident in images recorded off resonance (see FIGS. 3b and 3d). Indeed, the measured Raman spectra of the different compounds has two distinct peaks matching those expected for carotenoids^{22,23}.

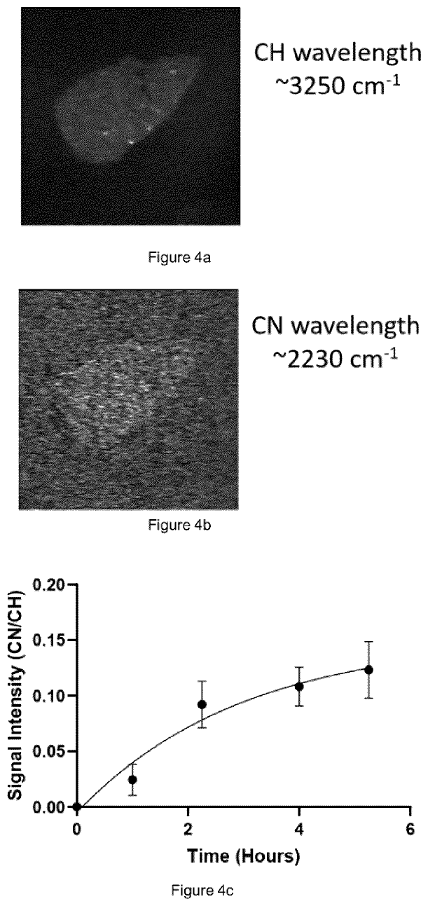

In one implementation, in imaging phytochemicals, the Raman signal of interest is strong, yet the non-resonant optical response is much larger, highlighting that CM-SRS can work with strong optical responses. For many biologically relevant systems, however, the optical responses are weak. To test the imaging performance of CM-SRS using weak signals, the uptake of a small molecule into cells is measured. Generally, pharmaceutical drugs are small molecules and used at low concentrations at therapeutic levels. Because the molecules are small, less than one kilodalton, traditional labeling schemes are not applicable: fluorescent labels are larger than these molecules and any measured biological activity would likely reflect the label, not the pharmaceutical drug. Raman labels, however, can be used by modifying the chemical structure of molecule of interest to include groups with Raman responses in the “quiet” region of cells^{24,25}. For example, using a model pharmaceutical drug labeled with nitrile groups, we measured the uptake of the compound into HepG2 cells. The pharmaceutical drug was loaded into the cells by incubating the cells in a 25 mM solution. To measure uptake, the cells are rinsed in fresh media before imaging. Using AM-SRS, non-resonant effects due to the heterogeneous structure of the cell dominate the image and it is not possible to observe the compound. Using CM-SRS, however, the loading of the compound into the cell is monitored over time, reaching a final concentration of 25 mM after approximately 5 hours, as can be seen in FIGS. 4a-4c.

The descriptions of the various implementations of the present disclosure have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

Implementations are described above with reference to block diagrams and/or operational illustrations of methods, systems. The operations/acts noted in the blocks may be skipped or occur out of the order as shown in any flow diagram. For example, two or more blocks shown in succession may be executed substantially concurrently or the blocks may sometimes be executed in the reverse order, depending upon the functionality/acts involved. While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for implementations.

### REFERENCES

1. Cheng, J.-X. & Xie, X. S. Coherent Raman Scattering Microscopy. (CRC Press, 2012).
2 Cheng, J.-X. & Xie, X. S. Vibrational spectroscopic imaging of living systems: An emerging platform for biology and medicine. Science 350, aaa8870 (2015).
3. Zhang, C., Zhang, D. & Cheng, J.-X. Coherent Raman Scattering Microscopy in Biology and Medicine. Annu. Rev. Biomed. Eng. 17, 415-445 (2015).
4. Freudiger, C. W. et al. Label-Free Biomedical Imaging with High Sensitivity by Stimulated Raman Scattering Microscopy. Science 322, 1857-1861 (2008).
5 Zumbusch, A., Holtom, G. R. & Xie, X. S. Three-Dimensional Vibrational Imaging by Coherent Anti-Stokes Raman Scattering. Phys. Rev. Lett. 82, 4142-4145 (1999).
6. Popov, K. I., Pegoraro, A. F., Stolow, A. & Ramunno, L. Image formation in CARS and SRS: effect of an inhomogeneous nonresonant background medium. Opt. Lett. 37, 473-475 (2012).
7. Kolk, J. van der, Lesina, A. C. & Ramunno, L. Effects of refractive index mismatch on SRS and CARS microscopy. Opt. Express 24, 25752-25766 (2016).
8. Andreana, M. et al. Amplitude and polarization modulated hyperspectral Stimulated Raman Scattering Microscopy. Opt. Express 23, 28119-28131 (2015).
9. Zhang, D., Slipchenko, M. N., Leaird, D. E., Weiner, A. M. & Cheng, J.-X. Spectrally modulated stimulated Raman scattering imaging with an angle-to-wavelength pulse shaper. Opt. Express 21, 13864-13874 (2013).
10. Hill, A. H., Munger, E., Francis, A. T., Manifold, B. & Fu, D. Frequency Modulation Stimulated Raman Scattering Microscopy through Polarization Encoding. J. Phys. Chem. B 123, 8397-8404 (2019).
11. Jiang, J. et al. Beyond intensity modulation: new approaches to pump-probe microscopy. Opt. Lett. 46, 1474-1477 (2021).
12. Xie, X. S., Freudiger, C. & Min, W. U.S. Pat. No. 8,027,032—Microscopy imaging system and method employing stimulated raman spectroscopy as a contrast mechanism. (2011).
13. Kikuchi, K. Fundamentals of Coherent Optical Fiber Communications. J. Light. Technol. 34, 157-179 (2016).
14. Dudovich, N., Oron, D. & Silberberg, Y. Single-pulse coherently controlled nonlinear Raman spectroscopy and microscopy. Nature 418, 512-514 (2002).
15. Silberberg, Y. Quantum Coherent Control for Nonlinear Spectroscopy and Microscopy. Annu. Rev. Phys. Chem. 60, 277-292 (2009).
16. Fraser, B. & Schewe, J. Real World Image Sharpening with Adobe Photoshop, Camera Raw, and Lightroom. (Peachpit Press, 2009).
17. Hellerer, T., Enejder, A. M. K. & Zumbusch, A. Spectral focusing: High spectral resolution spectroscopy with broad-bandwidth laser pulses. Appl. Phys. Lett. 85, 25-27 (2004).
18. Pegoraro, A. F. et al. Optimally chirped multimodal CARS microscopy based on a single Ti: sapphire oscillator. Opt. Express 17, 2984-2996 (2009).
19. Fu, D., Holtom, G., Freudiger, C., Zhang, X. & Xie, X. S. Hyperspectral Imaging with Stimulated Raman Scattering by Chirped Femtosecond Lasers. J. Phys. Chem. B 117, 4634-4640 (2013).
20. Berto, P., Andresen, E. R. & Rigneault, H. Background-Free Stimulated Raman Spectroscopy and Microscopy. Phys. Rev. Lett. 112, 053905 (2014).
21. Lombardini, A. et al. Background-suppressed SRS fingerprint imaging with a fully integrated system using a single optical parametric oscillator. Opt. Express 28, 14490-14502 (2020).
22. Altangerel, N. et al. In vivo diagnostics of early abiotic plant stress response via Raman spectroscopy. Proc. Natl. Acad. Sci. 114, 3393-3396 (2017).
23. Altangerel, N. et al. Reply to Dong and Zhao: Plant stress via Raman spectroscopy. Proc. Natl. Acad. Sci. 114, E5488-E5490 (2017).
24. Li, L., Wang, H. & Cheng, J.-X. Quantitative Coherent Anti-Stokes Raman Scattering Imaging of Lipid Distribution in Coexisting Domains. Biophys. J. 89, 3480-3490 (2005).
25. Pezacki, J. P. et al. Chemical contrast for imaging living systems: molecular vibrations drive CARS microscopy. Nat. Chem. Biol. 7, 137-145 (2011).
26. Abdolghader, P. et al. Unsupervised hyperspectral stimulated Raman microscopy image enhancement: denoising and segmentation via one-shot deep learning. Opt. Express 29, 34205-34219 (2021).

1. A modulation method comprising steps of:
a) generating a first signal having a first train of short pulses having a first frequency, and a second signal having a second train of short pulses having a second frequency, wherein each of the first signal and the second signal is associated with a negative or positive sign;
b) maintaining a narrow frequency difference between the first frequency and the second frequency;
c) imposing chirped modulation on the first signal and the second signal to achieve a desired spectral resolution, such that each signal is associated with a chirp having a first sign and a second sign; and
d) switching between the first sign and the second sign for each signal over a frequency range, and detecting for each frequency of said frequency range, a spectral response resulting from a transfer of said modulation between the first signal and the second signal wherein the chirp sign of the first signal is different from the chirp sign of the second signal, thereby obtaining hyperspectral data of said spectral response over said frequency range.

2. The modulation method of claim 1, wherein the transfer of said modulation between the first signal and the second signal results in a resonant response.

3. The modulation method of claim 2, comprising a substep of:
obtaining the spectral response by subtracting individual responses due to the chirped first signal and the chirped second signal from each other, thereby recovering peak positions, and thereby suppressing noise signals.

4. The modulation method of claim 3, wherein the resonant response is amplified, while a non-resonant response is removed.

5. The modulation method of claim 1, wherein at least one of the first signal and the second signal is tunable.

6. The modulation method of claim 5, wherein the first signal and the second signal are within the Raman spectrum.

7. The modulation method of claim 6, wherein a sample is microscopically probed by the chirped first signal and the chirped second signal.

8. The modulation method of claim 4, wherein the first signal and the second signal are generated by a laser source.

9. The modulation method of claim 4, wherein the first signal and the second signal are optical waves.

10. The modulation method of claim 4, wherein the first signal and the second signal are radio frequency waves.

11. A method of imaging a sample, the method comprising:
a) generating a pump beam and a Stokes beam comprising of a train of short pulses and having a tunable optical frequency difference;
b) imposing chirped modulation on the pump beam and Stokes beam to achieve a desired spectral resolution, such that each beam is associated with a chirp having a first sign and a second sign; and
c) probing regions of the sample with the pump beam and Stokes beam jointly, said probing comprising switching between the first sign and the second sign for each beam over an optical frequency range, said probing further comprising detecting, for each frequency of said optical frequency range for each of the probed regions, an optical response of the sample resulting from a transfer of said modulation between the pump beam and the Stokes beam when the chirp sign of the pump beam is different from the chirp sign of the Stokes beam, thereby obtaining hyperspectral data of said optical response over said optical frequency range for each of the probed regions.

12. The method of claim 11, wherein the probing of step c) comprises a substep of:
measuring the Raman spectrum using the chirped pump beam and the chirped beam with different signs.

13. The method of claim 12, wherein the probing of step c) comprises a substep of:
subtracting the two different responses to recover peak positions of the optical response.

14. The method of claim 12, wherein the sign of the chirp is rapidly modulated such that only Raman resonances are detected and amplified and non-resonant background channels are substantially suppressed or removed.

15. An imaging system comprising:
a light source system configured to produce a first set of light pulses in a predefined first wavelength region and a second set of light pulses in a predefined second wavelength region;
a modulator to positively chirp the first set of light pulses and negatively chirp the second set of light pulses;
a first optical system coupled to the light source system, the first optical system comprising optics configured to combine the first set of chirped light pulses and the second set of chirped light pulses into a set of combined light pulses, wherein each of the combined light pulses comprises a first pulse from the first set of chirped light pulses and a second pulse from the second set of chirped light pulses;
a sample holder coupled to the first optical system and configured to hold a sample for analysis, wherein at least a portion of the sample is exposed to a plurality of the combined light pulses;
a photodetector configured to convert an optical signal resulting from an interaction of the plurality of the combined light pulses with the sample;
an amplifier configured to remove the second set of chirped light pulses;
a second optical system configured to collect an interaction light signal resulting from an interaction of the at least one of the combined light pulses with the at least one of the particles;
an analysis system comprising spectrally dispersive means, the analysis system configured to measure a plurality of spectral components of the interaction light signal.

16. The imaging system of claim 15, wherein each set of light pulses is associated with a chirp having a first sign and a second sign.

17. The imaging system of claim 16, wherein the modulator switches the chirp between the first sign and the second sign for each set of light pulses over a frequency range, such that the first set of chirped light pulses and the second set of chirped light pulses comprise opposite chirp signs.

18. A modulation method of suppressing noise, the method comprising
a) generating a first signal having a first train of short pulses having a first frequency, and a second signal having a second train of short pulses having a second frequency, wherein each of the first signal and the second signal is associated with a negative or positive sign;
b) maintaining a narrow frequency difference between the first frequency and the second frequency;
c) imposing chirped modulation on the first signal and the second signal to achieve a desired spectral resolution, such that each signal is associated with a chirp having a first sign and a second sign; and
d) switching between the first sign and the second sign for each beam over a frequency range, and detecting for each frequency of said frequency range, a spectral response resulting from a transfer of said modulation between the first signal and the second signal wherein the chirp sign of the first signal is different from the chirp sign of the second signal, thereby obtaining hyperspectral data of said spectral response over said frequency range.

19. The modulation method of claim 18, wherein an amplifier configured to remove the second signal and amplify the first signal.

20. The modulation method of claim 19, wherein the first signal and the second signal are optical waves.

21. The modulation method of claim 19, wherein the first signal and the second signal are radio frequency waves.
